(19) United States
(12) Patent Application Publication
(10) Pub. No.: US 2012/0296677 A1
(43) Pub. Date: Nov. 22, 2012

(54) Systems and Methods for Online Sale of Artwork

(76) Inventors: Aditya JULKA, New York, NY (US); Alexander GILKES, New York, NY (US); Osman KHAN, New York, NY (US)

(21) Appl. No.: 13/475,801

(22) Filed: May 18, 2012

Related U.S. Application Data
(60) Provisional application No. 61/487,578, filed on May 18, 2011.

(51) Int. Cl. G06Q 30/06; G06Q 10/08; G06Q 40/08

(52) U.S. Cl. 705/4; 705/27.1; 705/28

(57) ABSTRACT

Systems and methods of transacting purchases of artwork using communications networks are disclosed. Such systems and methods for transacting a purchase of artwork using a communications network may comprise receiving offers to purchase artwork from collector client devices in communication with the communications network, each offer comprising an offer price; displaying, on a gallery client device in communication with the communications network, at least one of the offers, collector profile information corresponding to the at least one offer, and an option to accept the at least one offer; and transmitting to a collector client device an acceptance of one of the offers. The accepted price may be less than the highest offer price of the transmitted offers.

### CROSS REFERENCE TO RELATED APPLICATION

The present application claims the benefit of the earlier filing date of U.S. Patent Application No. 61/487,578 filed on May 18, 2011, the content of which is hereby incorporated by reference herein in its entirety.

### BACKGROUND

The current process for acquiring and selling art is disaggregated, largely inefficient and potentially time consuming and costly for both the collector and gallery. This inefficient, disaggregated process deters collectors from purchasing artwork they might otherwise be willing to acquire. The key challenges include payment processing, collection, insurance, and shipping.

Challenges relating to payment processing and collection can hinder artwork purchases. Collectors are typically only able to pay via wire transfer and check. Credit cards are seldom accepted even though a collector has a sufficient credit limit on a credit card. Manual invoices are time-consuming and inefficient to implement and are often lost in the mail and difficult to track. Payment collection often requires multiple calls from a gallery to a collector. Galleries are often wary of releasing an artwork before payment is received; while collectors are often wary of submitting payment before an artwork is released, deterring transactions between galleries and collectors not well-known to each other. Delays from collecting, authenticating, and processing wire transfers/checks can result in cash flow mismanagement concerns.

Challenges relating to insuring artwork can also hinder artwork purchases. For new collectors, fine art insurance is hard to identify and typically difficult to understand what the policy includes/excludes and whether it is appropriate for the artwork being bought. Galleries refer collectors to potential insurance agents, however the inability to offer insurance at point-of-sale can be a deterrent for a collector looking to acquire artwork.

Challenges relating to shipping of artwork can also hinder artwork purchases. There are several fine art shippers and quotes for a single shipment can vary dramatically by shipper, making it very hard for a collector to determine the right option. Shipping quotes are never provided at point-of-sale, so a collector never fully understands the total cost of purchasing an artwork. Most shipping policies are unclear on what they include and exclude, such as installation, so a new collector may not completely understand the terms of the shipping option selected. Registrars at galleries must spend hours manually contacting various shippers to determine what the best rate/quote for shipping an artwork will be—the process can take several days. Coordinating the actual shipment with the shipper and collector is also a time consuming and cumbersome process.

Shipping and insurance costs can be a substantial percentage of a purchase price of an artwork, but the exact amounts for these costs are typically unknown at the time of purchase, which can further deter artwork purchases. In addition, having to arrange each of shipping and insurance separately from the purchase itself also deters artwork purchases.

Whether at auction houses or through existing websites focused on art sales, artworks are typically purchased “as is” based on quoted prices or through an auction process. Although these acquisition constructs are fairly standard to the art market, they favor a collector who is able to pay the highest price point for a given artwork. However, when presented with two competing offers, galleries may often accept the lower offer based on a consideration of collector profiles. These acquisition constructs also do not reflect how art is actually purchased at a gallery, where price is not the sole determination for which collector will ultimately own the artwork. Rather, galleries also take into consideration a collector's reputation in the art market, existing portfolio of artwork and ownership history, familiarity with a particular artist/artwork and the art market broadly, or ability to facilitate or enhance the artwork's longer term value appreciation. These acquisition constructs further do not provide an adequate system for examining and submitting counteroffers which enhance the efficiency of the acquisition process.

When displaying artworks for sale, websites traditionally present static images accompanied by basic dimensions and limited zoom-in capabilities. This method of portraying the artwork makes it difficult for the collector to gauge the relative size of the work; discern and appreciate the intricacies of the artwork, particularly the medium, colors and styles employed by the artist; and examine the artwork at various angles to appreciate the ancillary, albeit equally important, features of the artwork, such as the canvas and frame type.

Most galleries share artworks for sale with collectors using digital images emailed to these collectors as attachments. These emails are often bulky and hard to open because of the size of the attachments. Also, the image files have limited viewing features and resolution, making it hard for collectors to get a zoomed view and to understand the relative size of the artworks. Furthermore, in order to generate these emails, the gallery employees have to first download the works from a separate inventory management system, and then compose emails in a second program, adding additional steps to the process of sharing artwork.

### SUMMARY

Systems and methods of transacting purchases of artwork using communications networks are disclosed.

An exemplary method for transacting a purchase of artwork using a communications network may include receiving offers to purchase artwork from collector client devices in communication with the communications network, each offer comprising an offer price; displaying, on a gallery client device in communication with the communications network, at least one of the offers, collector profile information corresponding to the at least one offer, and an option to accept the at least one offer; and transmitting to a collector client device an acceptance of one of the offers.

The accepted offer may include an offer price that is less than the highest offer price of the transmitted offers. The collector profile information may include information about a collector, the information including at least one of a list of artwork owned by the collector and a list of artwork purchased by the collector. The method may also include transmitting to a collector client device a counteroffer from the gallery client device or transmitting via the communications network a message between the gallery client device and a collector client device.

An exemplary method for transacting a purchase of artwork using a processor for executing instructions may include receiving an artwork selection indicating an artwork to be purchased and a corresponding purchase price; receiving an insurance selection for insuring the artwork; in response to the received insurance selection, generating an insurance quote for an insurance policy for the artwork; receiving a shipping selection corresponding to the purchase; in response to the shipping selection, generating a shipping quote for shipping the artwork based at least in part on characteristics of the artwork; receiving an installation selection for installing the artwork; in response to the installation selection, generating an installation quote for installing the artwork based at least in part on characteristics of the artwork; receiving an invoice request corresponding to the purchase; in response to the invoice request, generating an invoice comprising at least one of the purchase price, a consumption tax corresponding to the purchase, the insurance quote, the shipping quote, and the installation quote; receiving a payment selection corresponding to the purchase; in response to the payment selection, transmitting, via a communications network in communication with the processor, payment information corresponding to the payment selection; and generating the insurance policy for the artwork.

The method may also include transmitting, via the communications network, an acceptance of an offer to purchase the artwork, the offer comprising a price, where the artwork selection comprises the offer to purchase. The step of generating a shipping quote may include calculating a cost based on at least one of an origin location from where the artwork will be shipped, a destination location to where the artwork will be shipped, at least one dimension related to the artwork, and a packing cost to pack the artwork. The step of calculating a cost may include calculating a volume corresponding to the artwork based on the at least one dimension; determining an origin cost based on the volume and the origin location; determining a transit cost based on the volume, the origin location, and the destination location; determining a packing cost based on the volume; and calculating a sum of the origin cost, packing cost, and transit cost.

An exemplary method for managing an inventory of artwork using a processor for executing instructions may include receiving a request for a customized set of artworks from an artwork database in communication with the processor, the artwork database storing data corresponding to a plurality of artworks, including receiving at least one indicator corresponding to an artwork from the artwork database to include in the customized set, and receiving at least one indicator corresponding to a collector from a collector database in communication with the processor, the collector database storing data corresponding to a plurality of collectors; and in response to receiving the request for the customized set, providing, to the indicated collectors, access via a communications network to a presentation of the customized set of artworks.

The method may also include transmitting to a collector client device in communication with the communications network an invitation to view the presentation of the customized set of artworks; and generating a notification comprising an indicator corresponding to a collector, when the presentation of the customized set of artworks is viewed by the collector.

The method may also include transmitting to a collector client device in communication with the communications network the presentation of the customized set of artworks, the presentation including an option to purchase an artwork of the customized set; accepting a selection of the option to purchase; and in response to the selection of the option to purchase, transacting a purchase of the artwork.

The method may also include receiving an artwork selection indicating an artwork of the artwork database to be purchased and a corresponding purchase price; receiving an insurance selection for insuring the artwork; in response to the received insurance selection, generating an insurance quote for an insurance policy for the artwork; receiving a shipping selection corresponding to the purchase; in response to the shipping selection, generating a shipping quote for shipping the artwork based at least in part on characteristics of the artwork; receiving an installation selection for installing the artwork; in response to the installation selection, generating an installation quote for installing the artwork based at least in part on characteristics of the artwork; receiving an invoice request corresponding to the purchase; in response to the invoice request, generating an invoice comprising at least one of the purchase price, a consumption tax corresponding to the purchase, the insurance quote, the shipping quote, and the installation quote; receiving a payment selection corresponding to the purchase; in response to the payment selection, transmitting, via a communications network in communication with the processor, payment information corresponding to the payment selection; and generating the insurance policy for the artwork.

The method may also include accepting a request to modify data stored in the artwork database, the stored data comprising images and metadata associated with each artwork of the plurality of artworks. The artwork metadata may include a title, an artist, and at least one of dimensions, a price, an art category, year, and an exhibition including the artwork.

The method may also include accepting a request to modify data stored in the collector database, the stored data comprising a name, contact information, and a description of artistic preferences.

The presentation of the customized set of artworks may include at least one of an image of the artwork near an image of the selected object, a zoomed image of the artwork, a rotational image of the artwork, and multiple views of the artwork.

An exemplary method for presenting an image of artwork to a viewer using a processor for executing instructions includes receiving a set of dimensions of the artwork, selecting an object from a predetermined set of objects based on the received set of dimensions, and presenting to the viewer an image of the artwork near an image of the selected object. Each object of the predetermined set of objects may correspond to a predetermined range of dimensions. An object may be selected based on the received set of dimensions falling within the predetermined range of dimensions that corresponds to the selected object. The method may also include receiving a request from the viewer to purchase the artwork.

The foregoing and other objects, features and advantages of the invention will be apparent from the following more particular description of preferred embodiments of the invention, as illustrated in the accompanying drawings.

### BRIEF DESCRIPTION OF THE DRAWINGS

FIG. 1 depicts an illustrative system for transacting purchases of artwork, according to one embodiment of the disclosed subject matter.

FIGS. 2A-2B depict screenshots of illustrative webpages for a method for transacting a purchase of artwork using a communications network, according to one embodiment of the disclosed subject matter.

FIG. 3 depicts a method for transacting a purchase of artwork using a communications network, according to one embodiment of the disclosed subject matter.

FIGS. 4A-4H depict screenshots of illustrative webpages for a method for transacting a purchase of artwork using a communications network, according to one embodiment of the disclosed subject matter.

FIG. 5 depicts a method for transacting a purchase of artwork using a communications network, according to one embodiment of the disclosed subject matter.

FIGS. 6A-6K depict screenshots of illustrative webpages for a method for managing an inventory of artwork using a communications network, according to one embodiment of the disclosed subject matter.

FIG. 7 depicts a method for managing an inventory of artwork using a communications network, according to one embodiment of the disclosed subject matter.

FIGS. 8A-8C depict screenshots of illustrative webpages for a method for presenting an image of artwork to a viewer using a communications network, according to one embodiment of the disclosed subject matter.

FIG. 9 depicts a method for presenting an image of artwork to a viewer using a communications network, according to one embodiment of the disclosed subject matter.

### DETAILED DESCRIPTION

According to certain embodiments of the disclosed subject matter, systems and methods for the online sale of artwork are provided. As used herein, the term “artwork” may refer to a work of art, an antique, a collectible, or any other relatively unique or rare item.

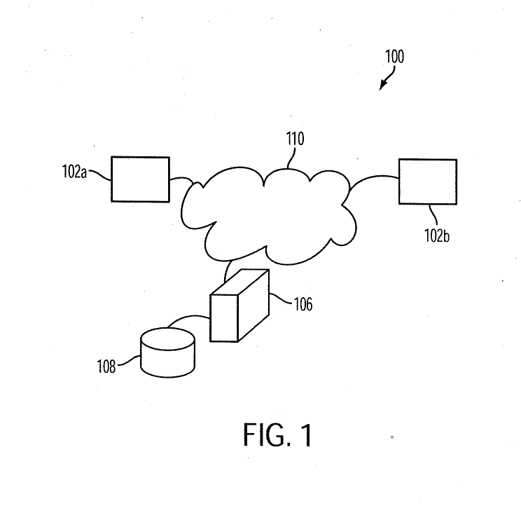

FIG. 1 depicts an illustrative system 100 for transacting purchases of artwork according to one embodiment of the disclosed subject matter. The system may include a gallery client device 102a, a collector client device 102b, and a server 106, which communicate over one or a combination of communications networks 110. The communication network 110 may be wired, wireless, or a combination thereof, and may be publicly accessible, such as the Internet, or part of a private communications network. Communications over the communications network 110 may be encrypted for reasons of security using any one of the well known encryption protocols. The server 106 can include a processor for executing instructions, such as transmitting webpages, emails, or other information in response to requests from client devices. The server 106 may have a corresponding storage device 108 that can be accessed or modified by client devices via the communications network 110. Storage device 108 may store multiple databases such as an artwork database of information corresponding to artworks or a collector database of information corresponding to collectors. Client devices 102 may include processors for executing instructions, such as transmitting or receiving requests, webpages served by server 106, and other information over the communications network 110, and displays capable of displaying the requests, webpages, or other information. Client devices 102 may have storage devices like storage device 108. System 100 may include multiple gallery client devices 102a or multiple collector client devices 102b. Each client device 102 may correspond to a different gallery/gallery owner or collector. A particular user (e.g., collector, gallery, gallery owner) may have access to and use multiple client devices 102, and the set of client devices 102 corresponding to a particular user may generally be referred to herein as a client device 102.

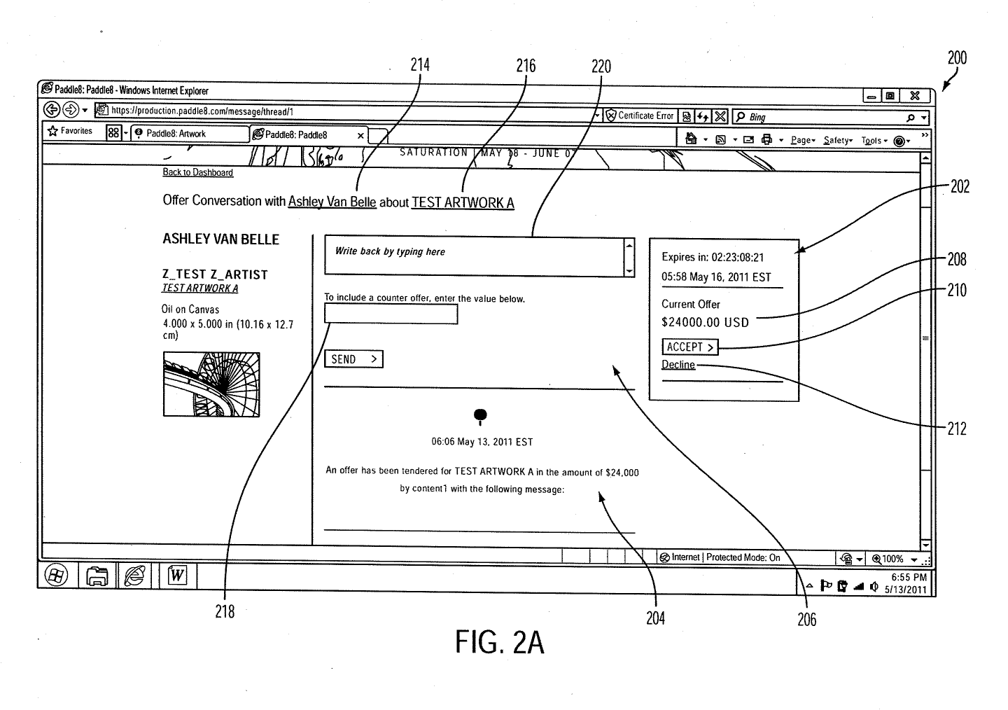

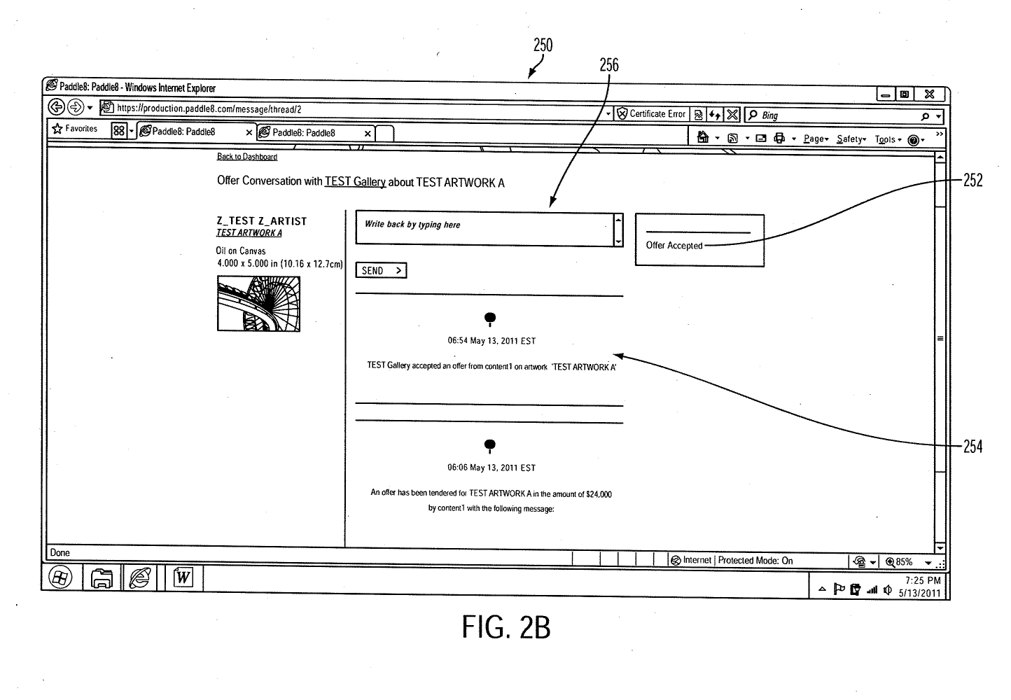

FIGS. 2A-2B depict screenshots of illustrative webpages for a method for transacting a purchase of artwork using a communications network, according to one embodiment of the disclosed subject matter.

FIG. 2A depicts a screenshot 200 of an illustrative webpage that can be displayed on a gallery client device 102a corresponding to a gallery or gallery owner according to one embodiment of the disclosed subject matter. The webpage includes a current offer area 202, previous message area 204, counteroffer area 206 and links 214 and 216 to other webpages. Link 214 leads to a webpage including collector profile information about the collector making the offer 208, such as artwork currently or previously owned by the collector, artwork purchased by the collector from the gallery, or artwork recently purchased by the gallery. Link 216 leads to a webpage including more information about the artwork, such as its artist, art category, or previous ownership history. The current offer area 202 displays an offer price 208, an accept option 210, to accept the offer price 208, and a decline option 212, to decline the offer 208. Instead of accepting or declining, a user of the gallery client device 102a can enter, into counteroffer area 206, a counteroffer price 218 with an optional message 220 accompanying the counteroffer price, to be transmitted via communications network 110 to a collector client device 102b of the collector making the offer 208. A user of the gallery client device 102a can enter a message 220 for receipt by the collector, without providing a counteroffer price 218. If a counteroffer is transmitted, collector client device 102b could display a similar screenshot to a collector, allowing the collector to accept, decline, or tender a counteroffer in response. Previous message area 204 displays previous messages and offers or counteroffers transmitted between the gallery and the collector.

A gallery client device 102a may receive multiple offers for the same artwork. A user of the gallery client device 102a may compare the multiple offers by viewing the corresponding webpages for each. In particular, a user may compare the prices offered by each collector and the collector profile information for each collector, to make a qualitative determination which offer is the most appealing. The user may accept an offer from a collector with a more appropriate collector profile, even though its offer price is not the highest.

FIG. 2B depicts a screenshot 250 of an illustrative webpage depicting an acceptance notification that can be displayed on a collector client device 102b corresponding to a collector according to one embodiment of the disclosed subject matter. The webpage includes a notification 252 that the collector's offer was accepted by the gallery; a previous message area 254, like previous message area 204 of FIG. 2A, that displays previous messages and offers or counteroffers transmitted between the gallery and the collector; and message area 256 in which the collector can enter a message for receipt by the gallery client device 102a. If the gallery had transmitted a counteroffer, that was accepted by the collector, then gallery client device 102a could display a similar screenshot to a user of the gallery device, notifying the user that the collector had accepted. A similar screenshot may also be used to notify a user that an offer or counteroffer has been declined by the other party.

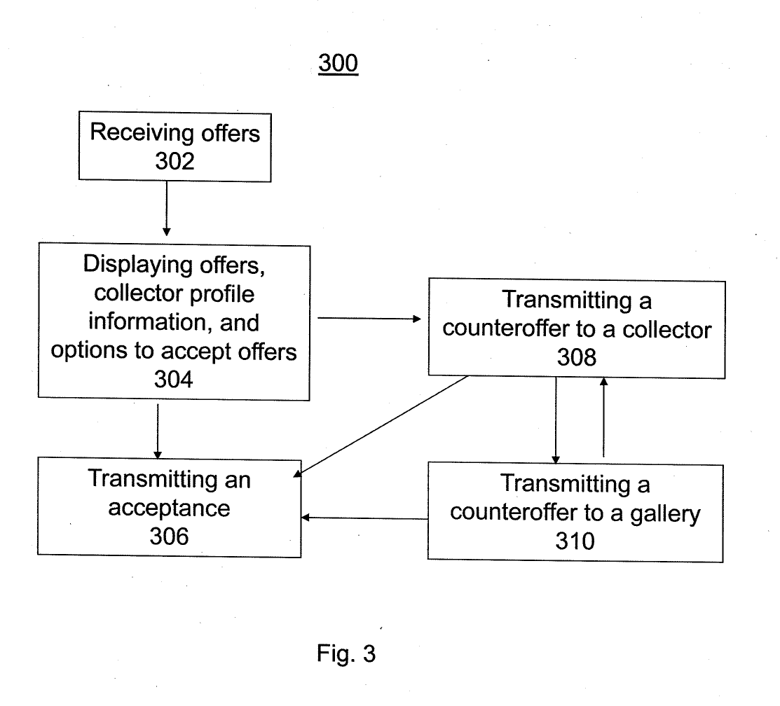

FIG. 3 depicts a method 300 for transacting a purchase of artwork using a communications network according to one embodiment of the disclosed subject matter. The method may include receiving offers from collectors to purchase artwork 302, displaying the offers, collector profile information corresponding to each offer, and options to accept offers 304, and transmitting an acceptance of one of the offers 306. Before an offer is accepted in step 306, the method may also include transmitting a counteroffer from the gallery to a collector 308 or transmitting a counteroffer from a collector to the gallery 310.

Each offer or counteroffer may include an offer price at which the collector is willing to purchase the artwork. The collector profile information may include a list of artwork owned by the collector or a list of artwork purchased by the collector. The acceptance of an offer may depend on the transmitted collector profile information. For example, an offer having more desirable collector profile information may be accepted despite having a lower offer price relative to other received offers. Messages may be transmitted between the gallery and a collector prior to acceptance of an offer, to facilitate communication between the gallery and a collector. Such messages may accompany an offer or counteroffer.

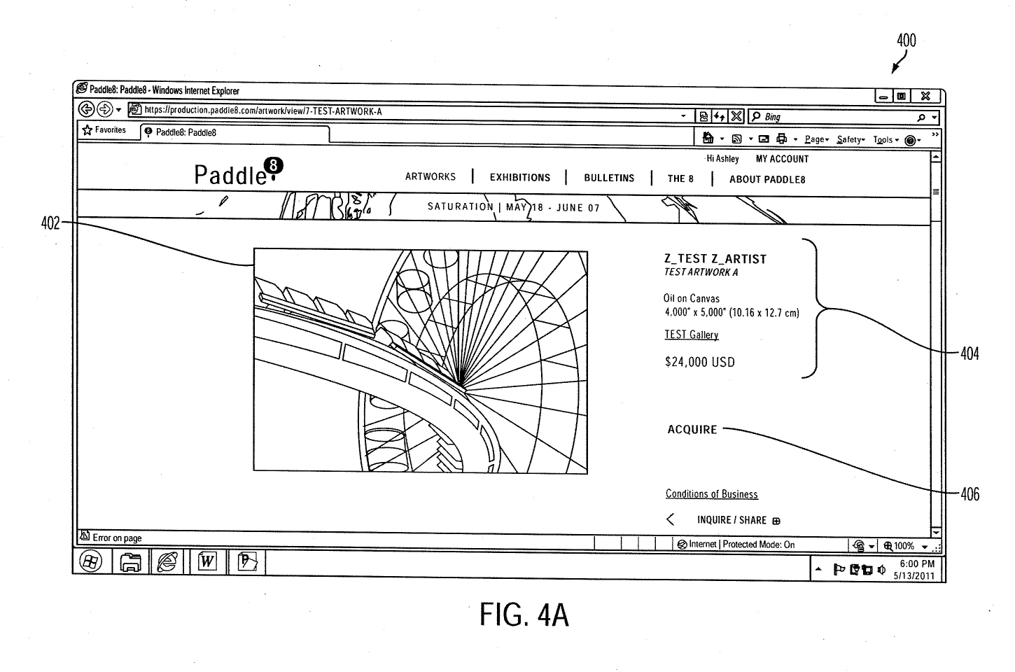

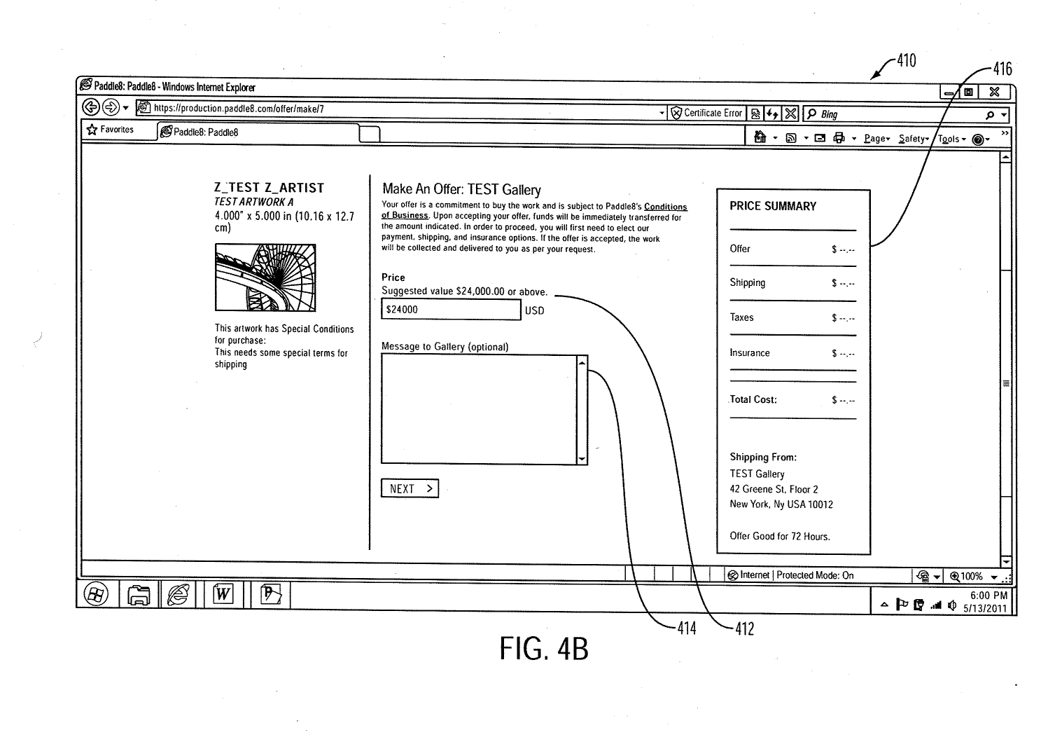

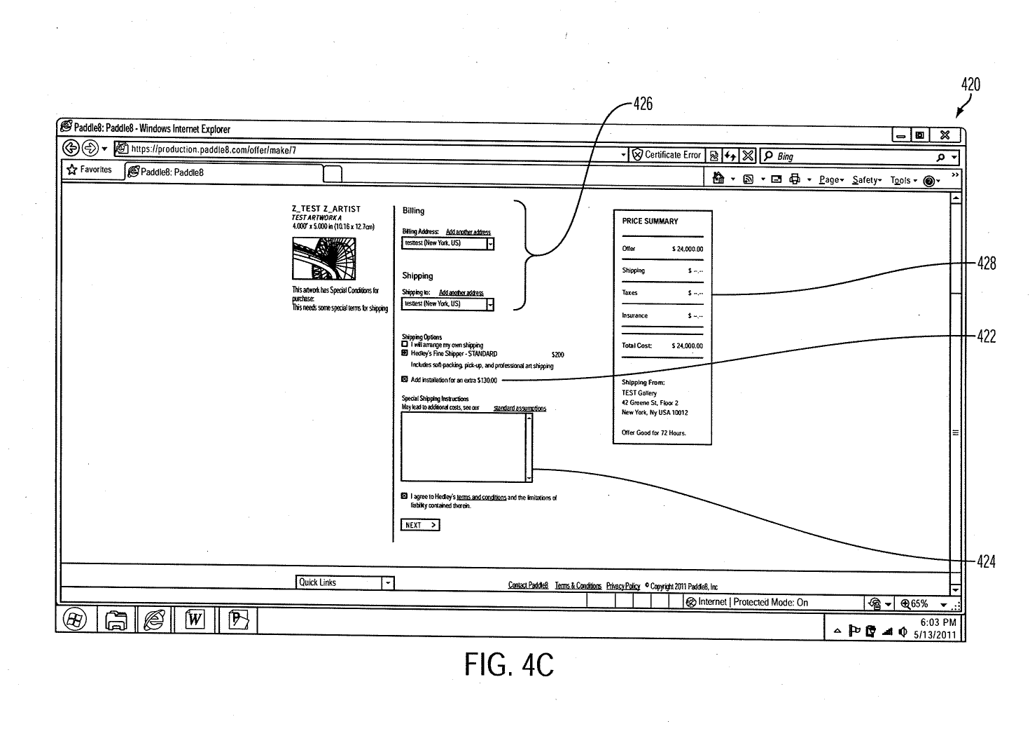

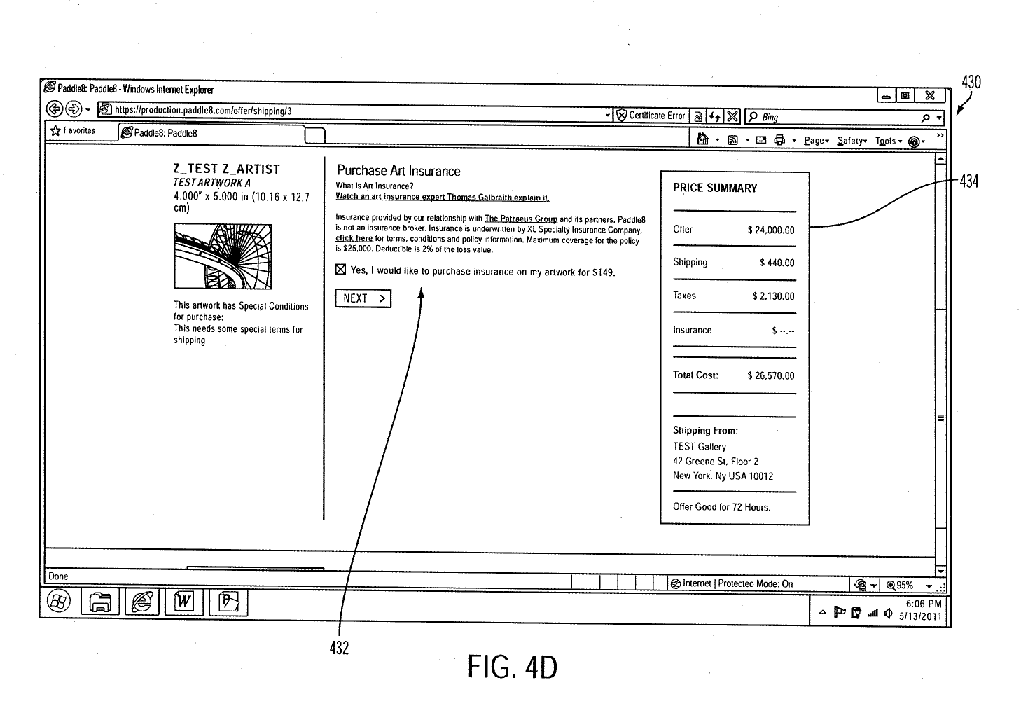

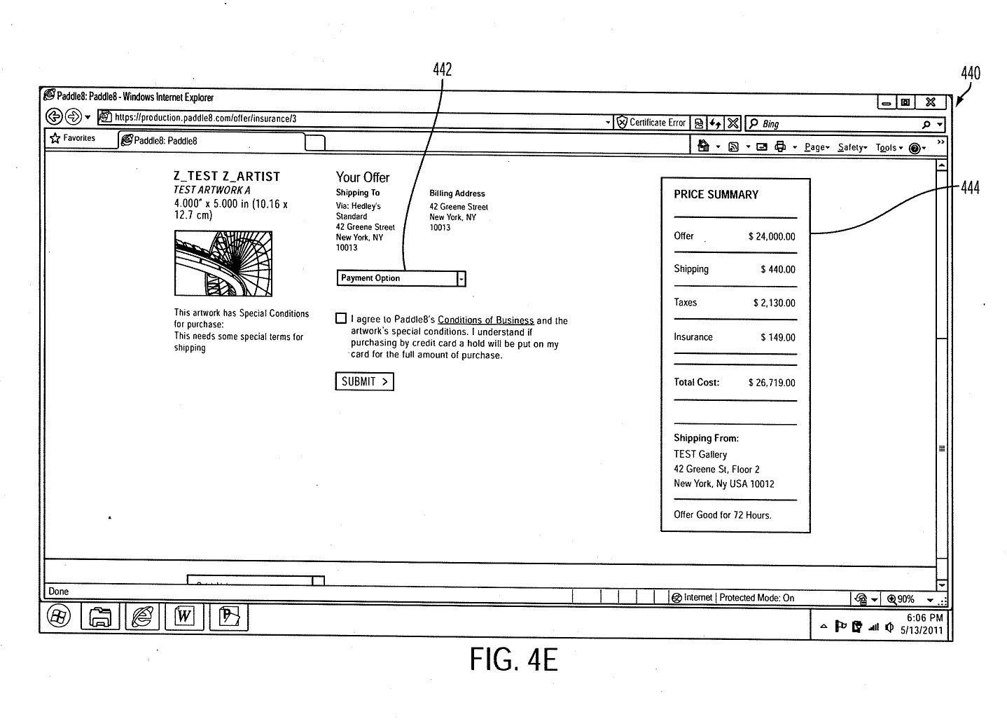

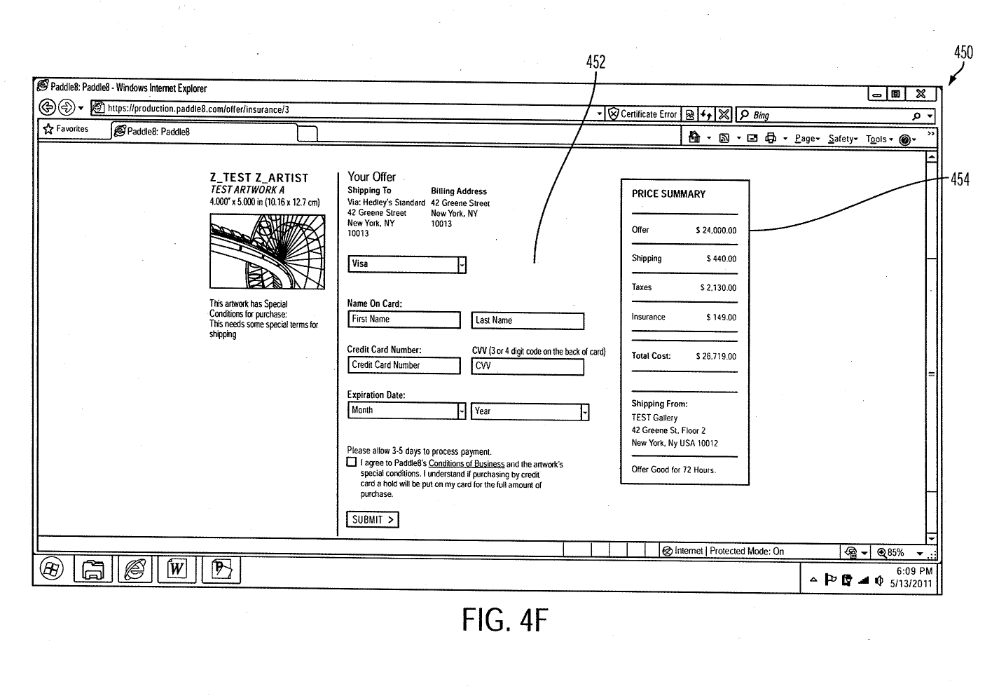

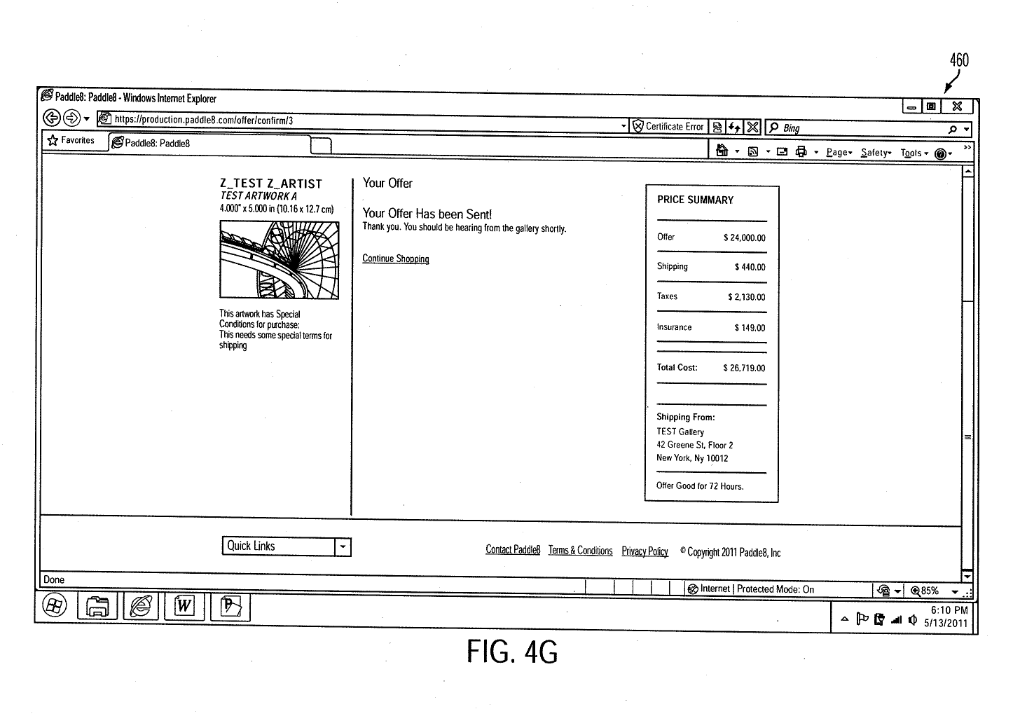

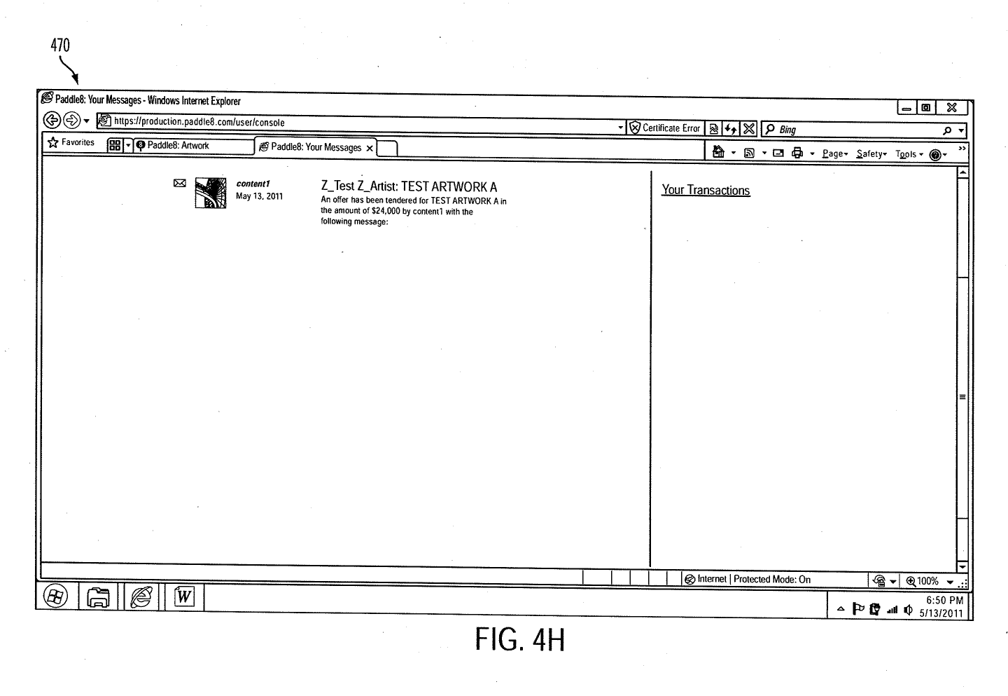

FIGS. 4A-4H depict screenshots of illustrative webpages for a method for transacting a purchase of artwork using a communications network, according to one embodiment of the disclosed subject matter.

FIG. 4A depicts a screenshot 400 of an illustrative webpage depicting an exemplary artwork that can be displayed on a client device 102 according to one embodiment of the disclosed subject matter. The webpage may include an image 402 of the artwork, metadata 404 associated with the artwork, and an acquire option 406 for purchasing the artwork. Metadata 404 may include a title, an artist, dimensions, a price, an art category, year, or an exhibition including the artwork.

FIG. 4B depicts a screenshot 410 of an illustrative webpage for initiating a purchase of the artwork or an offer to purchase the artwork that can be displayed on a client device 102 according to one embodiment of the disclosed subject matter. The webpage may include an offer price entry area 412, an optional message entry area 414, and a price summary area 416. The offer price entry area 412 may include an area in which to enter an offer price for an offer to purchase the artwork. Alternatively, the purchase price of the artwork may already be set. The price summary area 416 may include the prices associated with different parts of the transaction and a total sum of prices associated with selections made so far.

FIG. 4C depicts a screenshot 420 of an illustrative webpage for initiating a shipping selection that can be displayed on a client device 102 according to one embodiment of the disclosed subject matter. The webpage may include an address entry area 426 for entering shipping and billing addresses and an area 424 to enter special shipping instructions. The webpage may also include an area 422 for indicating an installation selection, to request installation of the artwork. The webpage may also include a price summary area 428 that includes prices for previous selections (e.g., offer price or list price of the artwork) and a total sum of prices associated with selections made so far.

In one embodiment of the disclosed subject matter, a shipping quote is generated in response to the shipping selection. The shipping quote can be based on, for example, a cost based on an origin location from where the artwork will be shipped, a destination location to where the artwork will be shipped, at least one dimension related to the artwork, or a packing cost to pack the artwork. For example, a shipping quote can be calculated by: calculating a volume corresponding to the artwork based on the at least one dimension; determining an origin cost based on the volume and the origin location; determining a transit cost based on the volume, the origin location, and the destination location; determining a packing cost based on the volume; or calculating a sum of the origin cost, packing cost, and transit cost. The volume could be calculated by finding the product of a length, width, and height of the artwork or finding the product of a length of the artwork plus a first fixed number, a width of the artwork plus a second fixed number, or a height of the artwork plus a third fixed number, where the fixed numbers could be the same or different. The origin cost, packing cost, or transit cost can be calculated as a product of the volume and a rate of price per volume, where the rate may depend on a location such as the origin or destination locations. The origin cost, packing cost, or transit cost could be the larger of this product and a minimum bar set for the cost. The rate can vary depending on the level of service selected. For example, the packing rate could depend on the quality of packing desired. In addition, a weight of the artwork can be used instead of or in addition to a volume.

In one embodiment of the disclosed subject matter, an installation quote is generated in response to the installation selection. The installation selection can be based on, for example, the shipping selection, at least one dimension related to the artwork, or an art category to which the artwork belongs.

FIG. 4D depicts a screenshot 430 of an illustrative webpage for initiating an insurance selection that can be displayed on a client device 102 according to one embodiment of the disclosed subject matter. The insurance selection indicates a request for an insurance policy for the artwork. The insurance policy can be, for example, offered at a fixed insurance quote for any offer price or list price below a predetermined upper bound. In response to the insurance selection, the insurance policy can be automatically generated. The webpage may include an area 432 in which to indicate the insurance selection and a price summary area 434 that includes prices for previous selections (e.g., offer price or list price of the artwork, shipping quote provided in response to a shipping selection, installation quote provided in response to an installation request, consumption tax based on at least the artwork price such as a sales tax or VAT (value added tax)) and a total sum of prices associated with selections made so far.

FIG. 4E depicts a screenshot 440 of an illustrative webpage for initiating a payment selection for paying for the artwork purchase that can be displayed on a client device 102 according to one embodiment of the disclosed subject matter. The webpage includes a drop-down menu 442 of payment options, such as wire transfer, credit card, or other payment systems capable of executing payment over a communications network. The webpage may include a price summary area 444 that includes prices for previous selections (e.g., offer price or list price of the artwork, shipping quote provided in response to a shipping selection, installation quote provided in response to an installation request, consumption tax based on at least the artwork price such as a sales tax or VAT (value added tax), insurance quote provided in response to an insurance selection), and a total sum of prices associated with selections made so far.

FIG. 4F depicts a screenshot 450 of an illustrative webpage for entering payment information relevant to a particular payment selection that can be displayed on a client device 102 according to one embodiment of the disclosed subject matter. For example, if the payment selection comprises credit card as a form of payment for the artwork purchase, the webpage may include credit card information entry area 452 for entering credit card information such as name, credit card number, credit card security code, credit card expiration date, and type of credit card. The payment information may be transmitted over a communications network 110 for processing the payment for the artwork purchase. For example, the payment information may be transmitted to a server for processing credit card payments or a server for processing wire transfers from accounts. The webpage may also include a price summary area 454, similar to the price summary area of FIG. 4E.

In one embodiment of the disclosed subject matter, the payment may be transmitted to a third party for holding. The third party may transmit some portion of the purchase price, such as 50%, to the gallery selling the purchased artwork. The gallery, upon receipt of the partial payment or a notification of the partial payment transfer, may release the purchased artwork for delivery to the purchasing collector. The third party, upon receipt of a notification or confirmation that the purchased artwork has been released by the gallery, may transmit the remaining portion of the payment due to the gallery. Any of the payment transmissions, notifications, or confirmations may occur over the communications network 110.

FIG. 4G depicts a screenshot 460 of an illustrative webpage for displaying a notification on a client device 102 indicating when the information relevant to the artwork purchase has been transmitted according to one embodiment of the disclosed subject matter. FIG. 4H depicts a screenshot 470 of an illustrative webpage for displaying a notification on client device 102 indicating when the information relevant to the artwork purchase has been received according to one embodiment of the disclosed subject matter. In some embodiments of the disclosed subject matter, the notification indicating when the information has been transmitted is displayed on a collector client device. In some embodiments, the notification indicating when the information has been received is displayed on a gallery collector device.

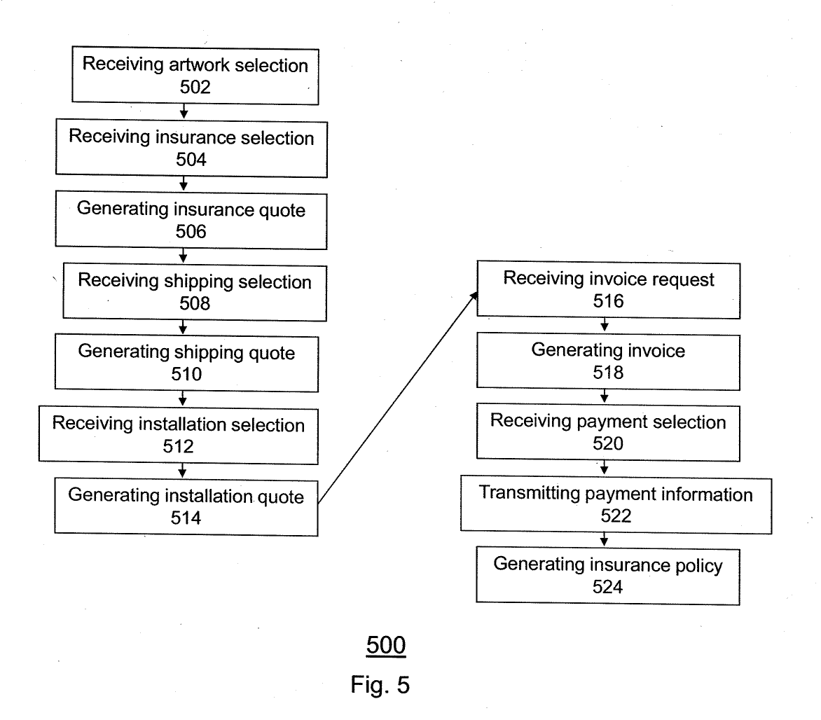

FIG. 5 depicts a method 500 for transacting a purchase of artwork using a processor for executing instructions according to one embodiment of the disclosed subject matter. The method may include receiving an artwork selection indicating an artwork to be purchased and a corresponding purchase price 502, receiving an insurance selection for insuring the artwork 504, generating in response to the received insurance selection an insurance quote for an insurance policy for the artwork 506, receiving a shipping selection corresponding to the purchase 508, generating in response to the shipping selection a shipping quote for shipping the artwork 510, receiving an installation selection for installing the artwork 512, generating in response to the installation selection an installation quote for installing the artwork 514, receiving an invoice request corresponding to the purchase 516, generating in response to the invoice request an invoice 518, receiving a payment selection corresponding to the purchase 520, transmitting in response to the payment selection payment information corresponding to the payment selection 522, and generating the insurance policy for the artwork 524. The payment information may be transmitted to a payment processor, such as a credit card company or bank, for processing the payment. The insurance policy may be generated in response to the payment processing.

The invoice may include a purchase price corresponding to the purchase, a consumption tax (such as a sales tax or VAT) corresponding to the purchase, an insurance charge for the insurance policy, the shipping quote, the installation quote, or a total of all amounts. The insurance policy, shipping quote, or installation quote may be automatically generated and may be based at least in part on characteristics of the purchased artwork. The shipping quote may be generated by calculating a cost based on an origin location from where the artwork will be shipped, a destination location to where the artwork will be shipped, at least one dimension related to the artwork, or a packing cost to pack the artwork. For example, the cost may be calculated by calculating a volume based on dimensions of the artwork; determining an origin cost based on the volume and the origin location; determining a transit cost based on the volume, the origin location, and the destination location; determining a packing cost based on the volume; or calculating a sum of the origin cost, packing cost, and transit cost.

The artwork selection may include an offer to purchase, where the offer includes a price. The method may also include transmitting an acceptance of the offer to purchase.

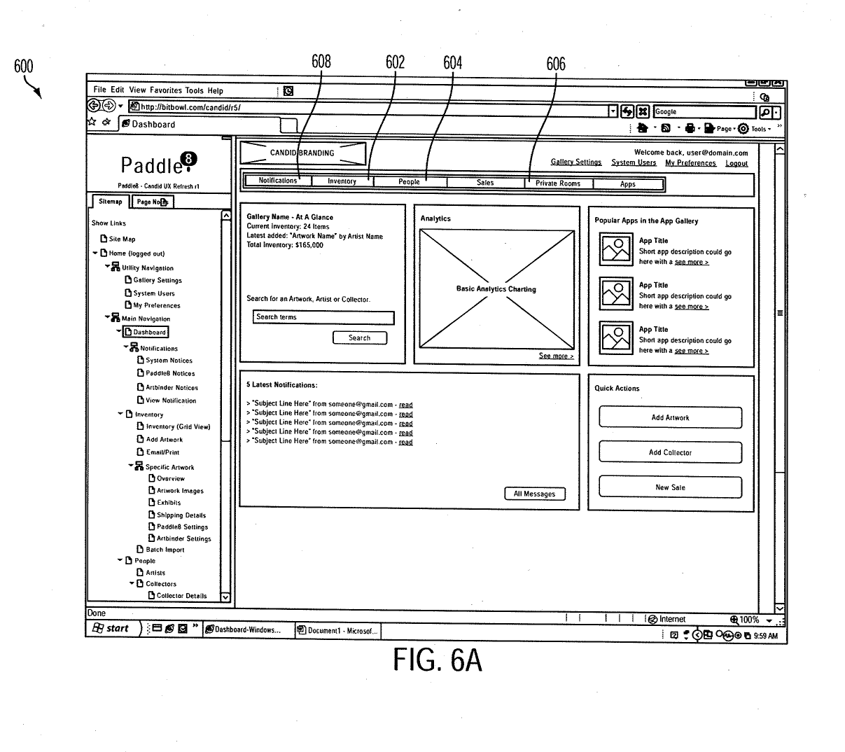

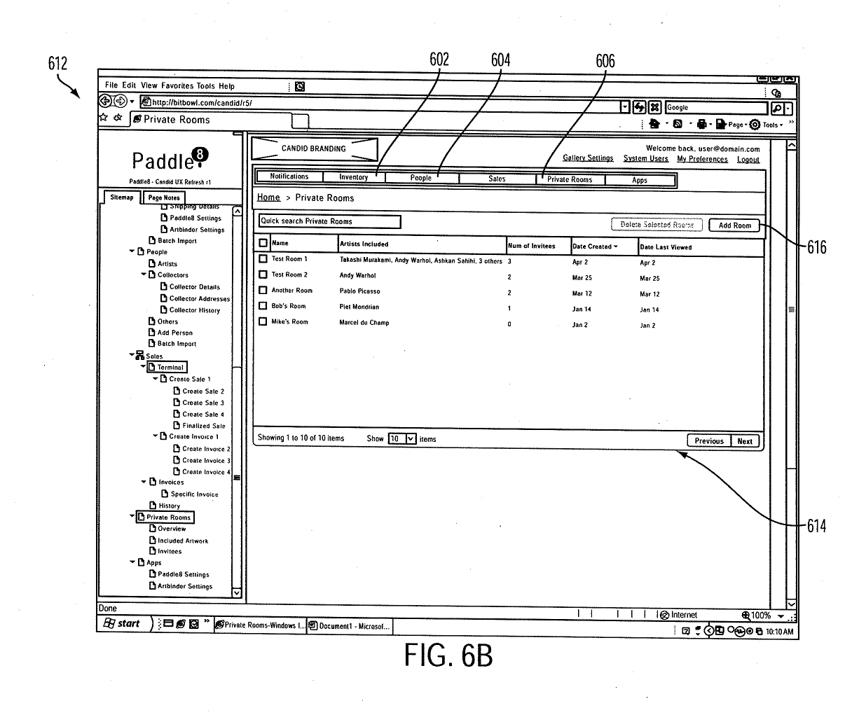

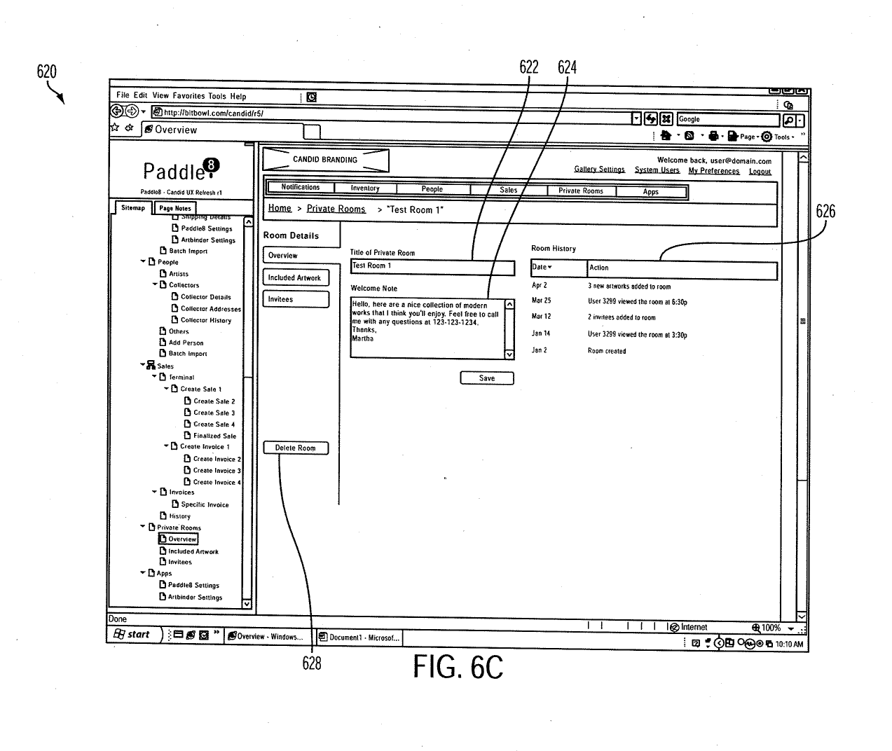

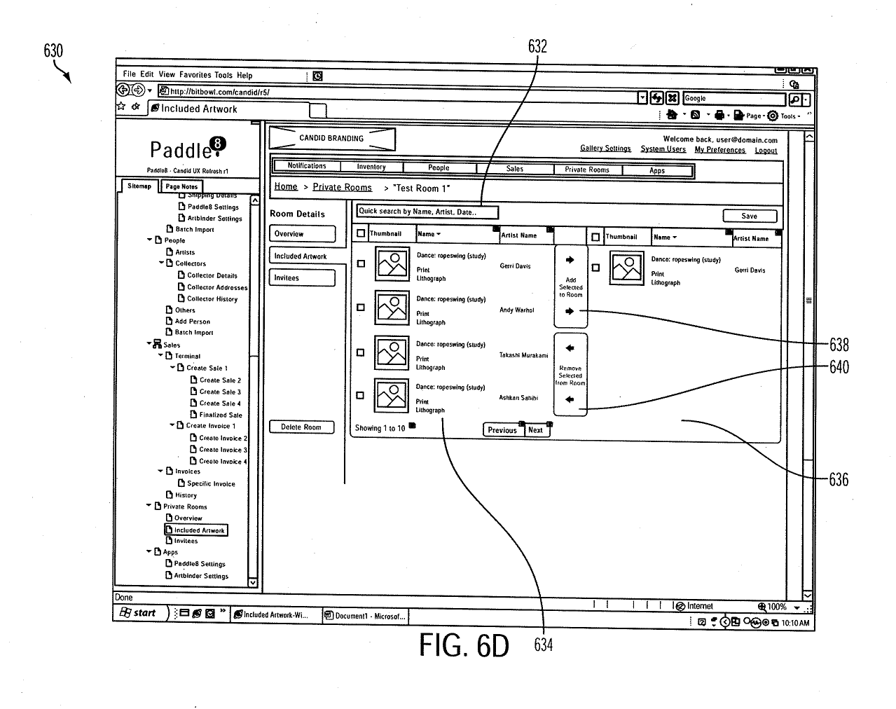

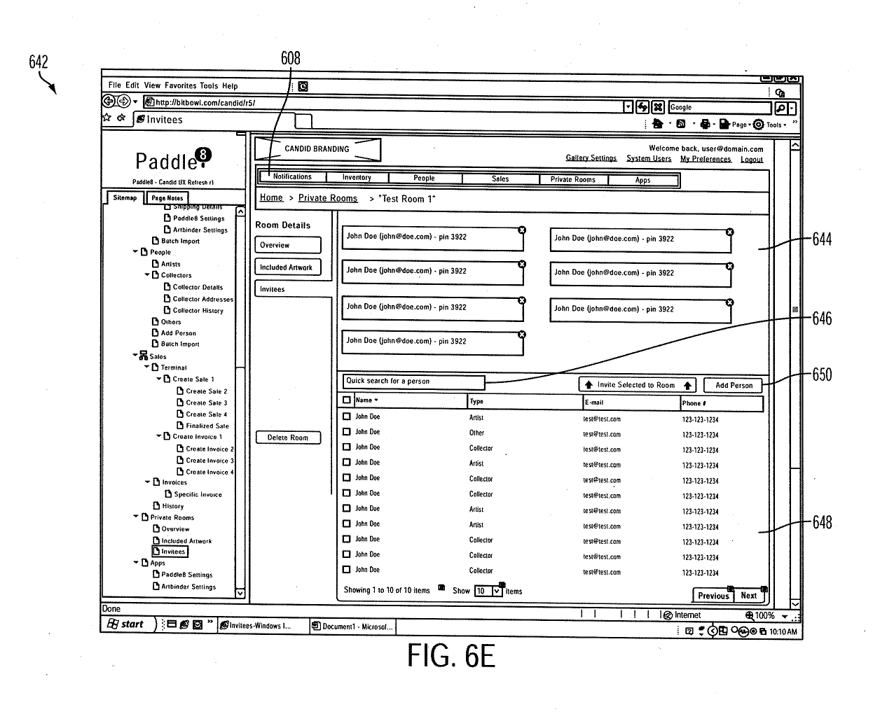

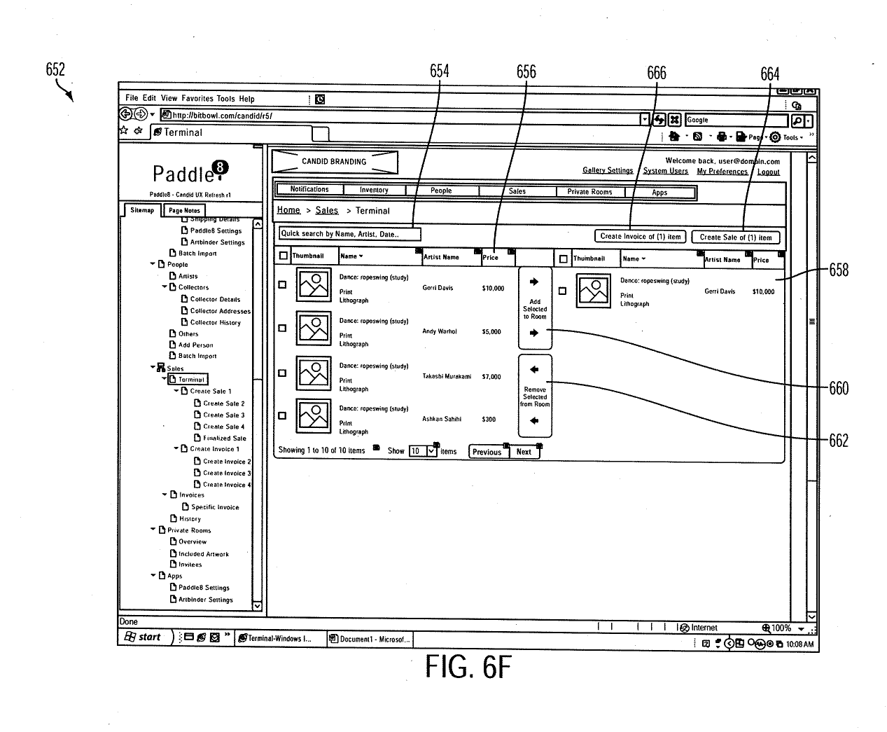

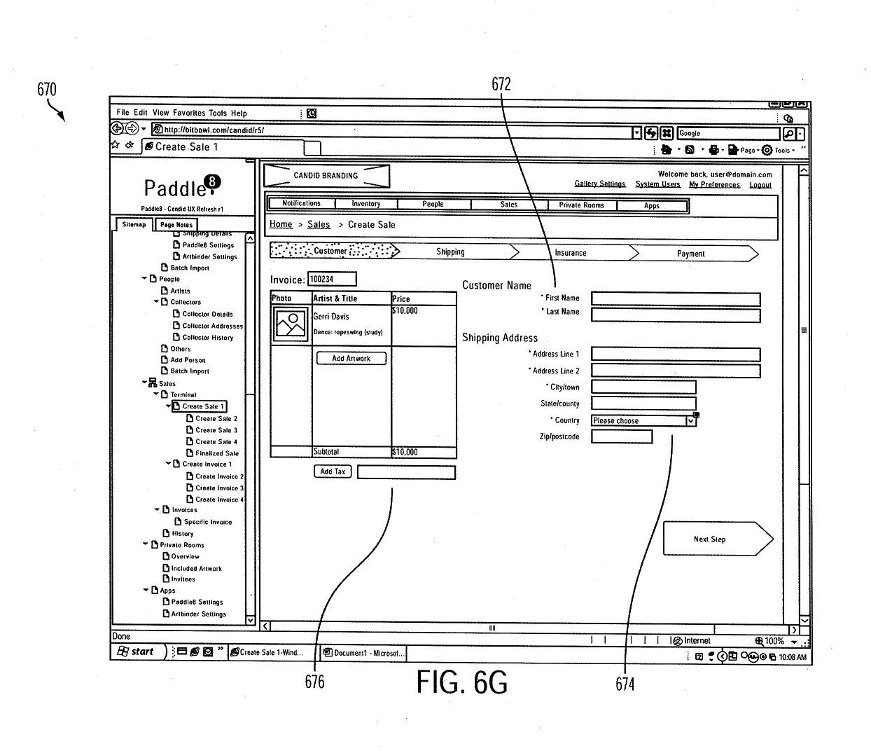

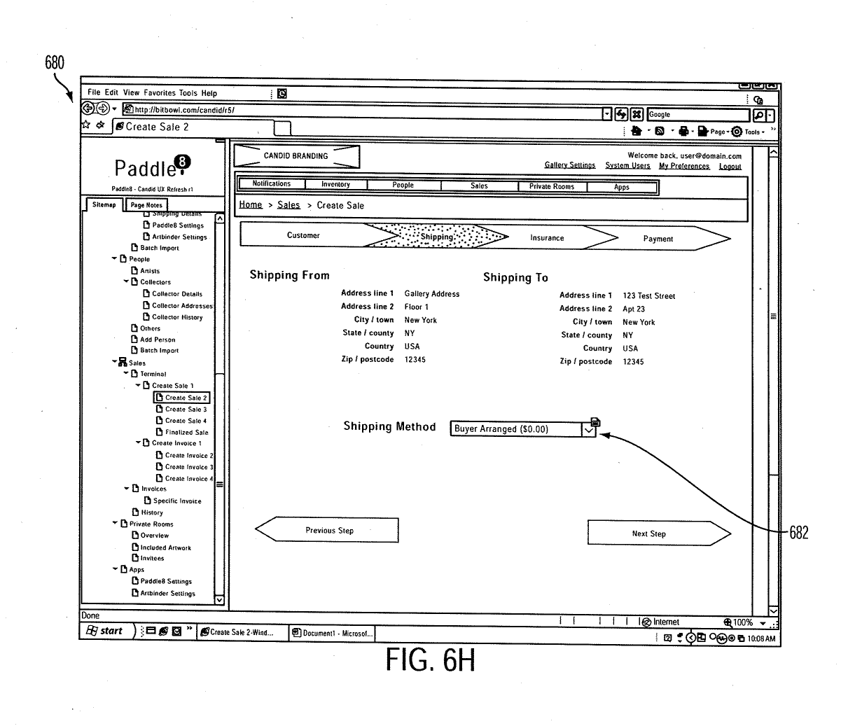

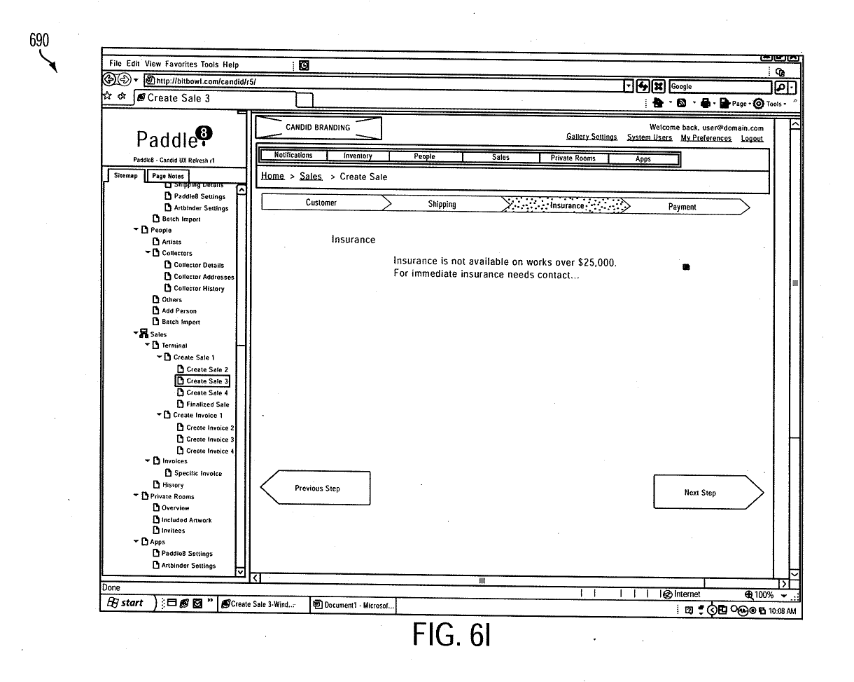

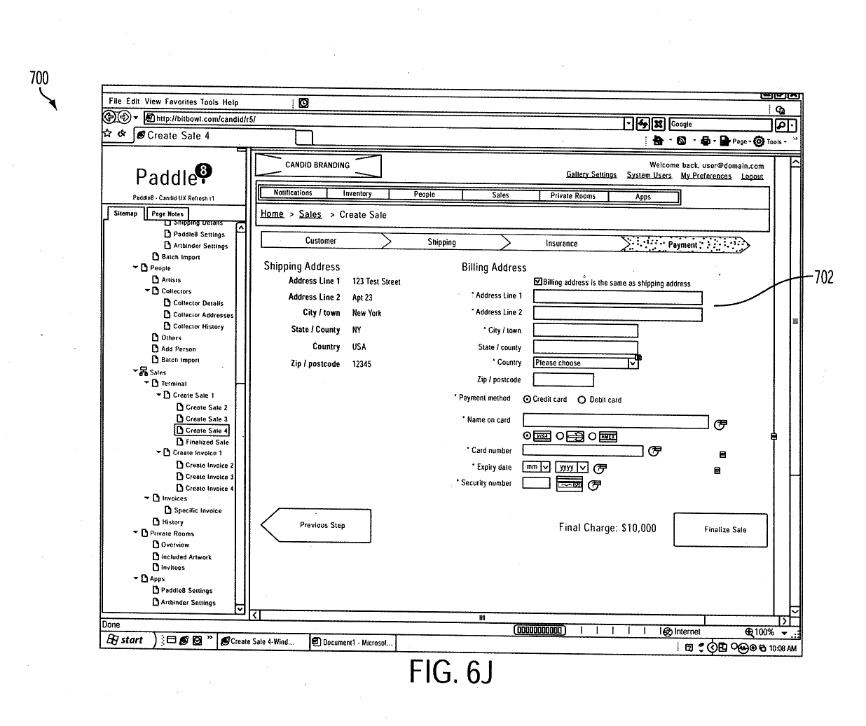

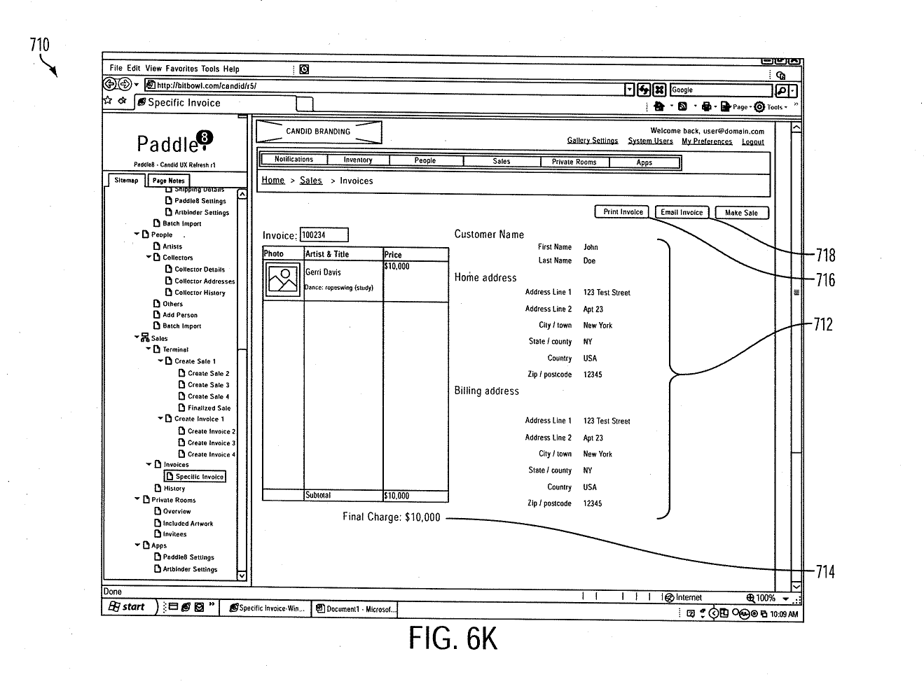

FIGS. 6A-6K depict screenshots of illustrative webpages for a method for managing an inventory of artwork using a communications network, according to one embodiment of the disclosed subject matter.

FIG. 6A depicts a screenshot 600 of an illustrative webpage for managing an inventory of artwork using a communications network that can be displayed on a client device 102 according to one embodiment of the disclosed subject matter. The webpage may include tabs providing access to different inventory management features. Inventory tab 602 may provide access to an artwork database, stored on a storage device 108 in communication with the communications network 110. The artwork database stores an inventory of artwork including images of and metadata associated with the artwork. People tab 604 may provide access to a database, stored on a storage device 108 in communication with the communications network 110. The database stores data corresponding to individuals such as collectors or artists. For example, the database can include a collector database storing data corresponding to a plurality of collectors. Private Rooms tab 606 provides access to an inventory management feature for creating customized sets of artwork from the artwork database for presentation to a selected set of collectors from the collector database. Notifications tab 608 may provide access to notifications, such as, for example, when a collector accesses a customized presentation.

FIG. 6B depicts a screenshot 612 of an illustrative webpage accessed from the Private Rooms tab 606 that can be displayed on a client device 102 according to one embodiment of the disclosed subject matter. The webpage may include a list 614 of customized sets of artwork and a button 616 for creating a new customized set.

FIG. 6C depicts a screenshot 620 of an illustrative webpage for a customized set of artwork that can be displayed on a client device 102 according to one embodiment of the disclosed subject matter. The webpage may include a title entry area 622 for viewing or modifying the title of the customized set, a message entry area 624 for viewing or modifying a message for collectors having access to the customized set, and a history 626 of the customized set, the history including, for example, when the customized set was created or modified or when collectors were provided access or viewed the artwork of the customized set. The webpage may also include a button 628 for deleting the customized set.

FIG. 6D depicts a screenshot 630 of an illustrative webpage depicting artwork in the customized set depicted in FIG. 6C that can be displayed on a client device 102 according to one embodiment of the disclosed subject matter. The webpage may include a search entry area 632, a search results area 634, and a customized set area 636. Search queries can be entered into the search entry area 632. Search results, found by searching metadata associated with artwork and stored in an artwork database, based on an entered search query, are shown in search results area 634. Artwork listed in the search results area 634 can be added to the customized set using button 638. Artwork listed in the customized set area 636 can be removed from the customized set using button 640.

FIG. 6E depicts a screenshot 642 of an illustrative webpage depicting the selected set of collectors having access to the customized set depicted in FIG. 6C that can be displayed on a client device 102 according to one embodiment of the disclosed subject matter. The webpage may include a selected set area 644, a search entry area 646, and a search results area 648. Search queries can be entered into the search entry area 646. Search results, found by searching data corresponding to collectors and stored in a collector database, based on an entered search query, are shown in search results area 648. Collectors listed in the search results area 648 can be added to the customized set using button 650. collectors listed in the selected set area 644 can be removed by using the X button near each collector's listing. Collectors listed in the selected set area 644 may have access to a presentation of the customized set of artwork shown in the customized set area 636 of FIG. 6D. When collectors are added to the selected set, a notification can be sent, via the communications network 110, to the added collectors. The notification can, for example, include the message of message entry area 624 of FIG. 6C. When collectors of the selected set access the presentation of the customized set of artwork, a notification can be sent, via the communications network 110, and can be accessed, for example, by the notifications tab 608.

FIG. 6F depicts a screenshot 652 of an illustrative webpage for transacting or invoicing a purchase of an artwork that can be displayed on a client device 102 according to one embodiment of the disclosed subject matter. The webpage may include a search entry area 654, a search results area 656, and a selected artwork area 658 listing art in the customized set. Search queries can be entered into the search entry area 654. Search results, found by searching metadata associated with artwork and stored in an artwork database, based on an entered search query, are shown in search results area 656. Artwork listed in the search results area 656 can be added to the selected artwork area 658 using button 660. Artwork listed in the selected set area 658 can be removed from the customized set using button 662. A purchase of artwork(s) listed in the selected artwork area can be initiated using button 664. An invoice for artwork(s) listed in the selected artwork area can be generated using button 666. The transacting of a purchase of artwork can include steps, or otherwise be similar to, the transactions described with respect to FIGS. 4A-4H and 5.

FIG. 6G depicts a screenshot 670 of a first illustrative webpage for transacting a purchase of an artwork that can be displayed on a client device 102 according to one embodiment of the disclosed subject matter. The webpage may include a customer name area 672 for entering a purchaser's name, a shipping address area 674 for entering a shipping address to which the artwork will be shipped, and an area 676 for calculating the tax associated with the purchase, such as a sales tax or VAT.

FIG. 6H depicts a screenshot 680 of a second illustrative webpage for transacting a purchase of an artwork that can be displayed on a client device 102 according to one embodiment of the disclosed subject matter. The webpage may include a drop-down menu 682 allowing the initiation of a shipping selection for shipping the artwork.

FIG. 6I depicts a screenshot 690 of a third illustrative webpage for transacting a purchase of an artwork that can be displayed on a client device 102 according to one embodiment of the disclosed subject matter. The webpage may allow the initiation of an insurance selection for insuring the artwork.

FIG. 6J depicts a screenshot 700 of a fourth illustrative webpage for transacting a purchase of an artwork that can be displayed on a client device 102 according to one embodiment of the disclosed subject matter. The webpage may include payment information area 702 for entering payment information such as a billing address, credit card information, or account information.

Webpages, similar to those of FIGS. 6G-6J, can be used to generate an invoice for an artwork. FIG. 6K depicts a screenshot 710 of an illustrative webpage for accessing a generated invoice that can be displayed on a client device 102 according to one embodiment of the disclosed subject matter. The webpage may include a customer information area 712 and a price summary area 714. The customer information area 712 may include customer information such as the customer name, shipping or home address, and billing address. The price summary area 714 can include information similar to that of the price summary areas depicted in FIGS. 4A-4H, such as a purchase price, shipping price, installation price, insurance price, tax, and a total of all charges. The generated invoice can be printed out or transmitted via the communications network 110 using buttons 716 and 718, respectively.

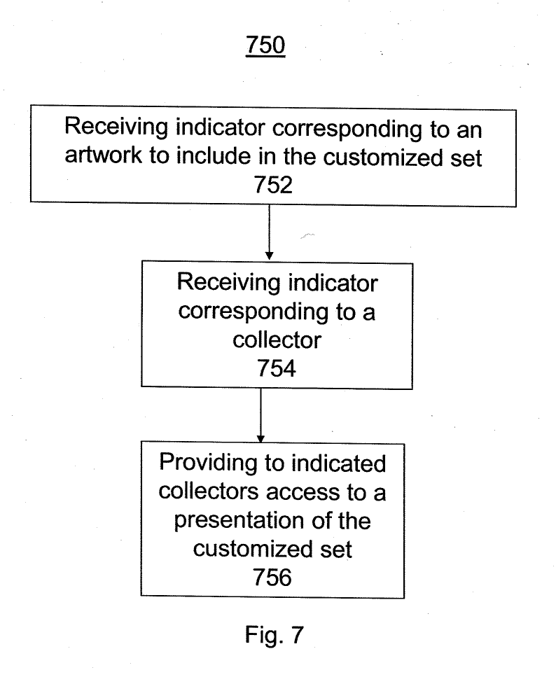

FIG. 7 depicts a method 750 for managing an inventory of artwork using a processor for executing instructions according to one embodiment of the disclosed subject matter. The method may include receiving a request for a customized set of artworks, the step comprising receiving at least one indicator corresponding to an artwork to include in the customized set 752 and receiving at least one indicator corresponding to a collector 754, and in response to receiving the request for the customized set providing, to indicated collectors, access to a presentation of the customized set of artworks 756.

The indicated artworks of the customized set may be drawn from an artwork database that stores data corresponding to a plurality of artworks. Data stored in the artwork database may be images or metadata associated with each stored artwork. Exemplary metadata may include a title, an artist, one or more dimensions, a price, an art category, a year, or an exhibition in which the artwork was exhibited. The indicated collectors may be drawn from a collector database that stores data associated with collectors such as a name, contact information, or a description of artistic preferences. Data stored in the artwork database or collector database may be modified by, for example, modifying metadata or adding or removing artworks or collectors.

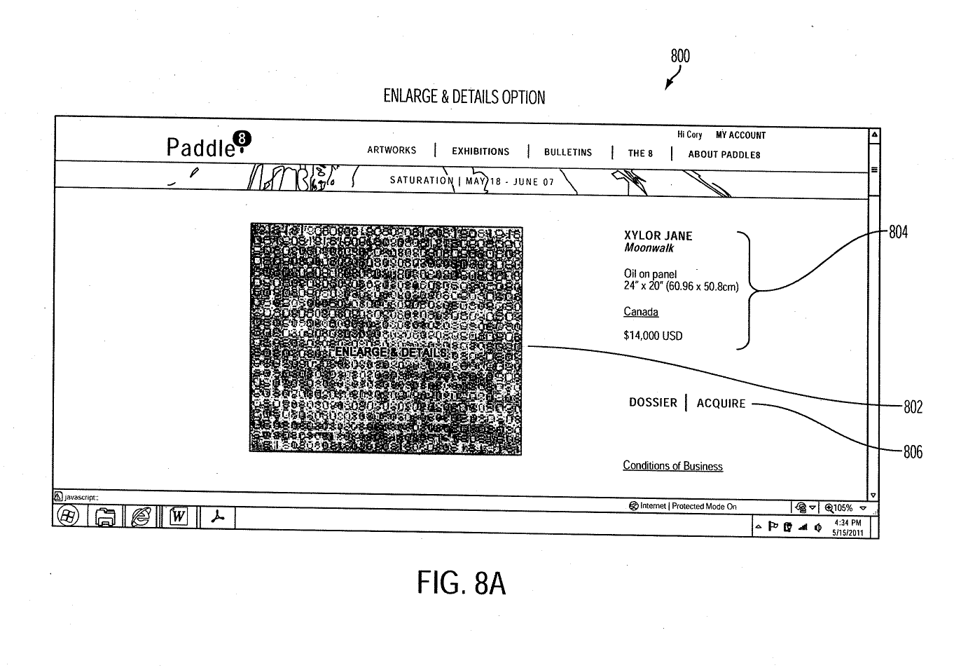

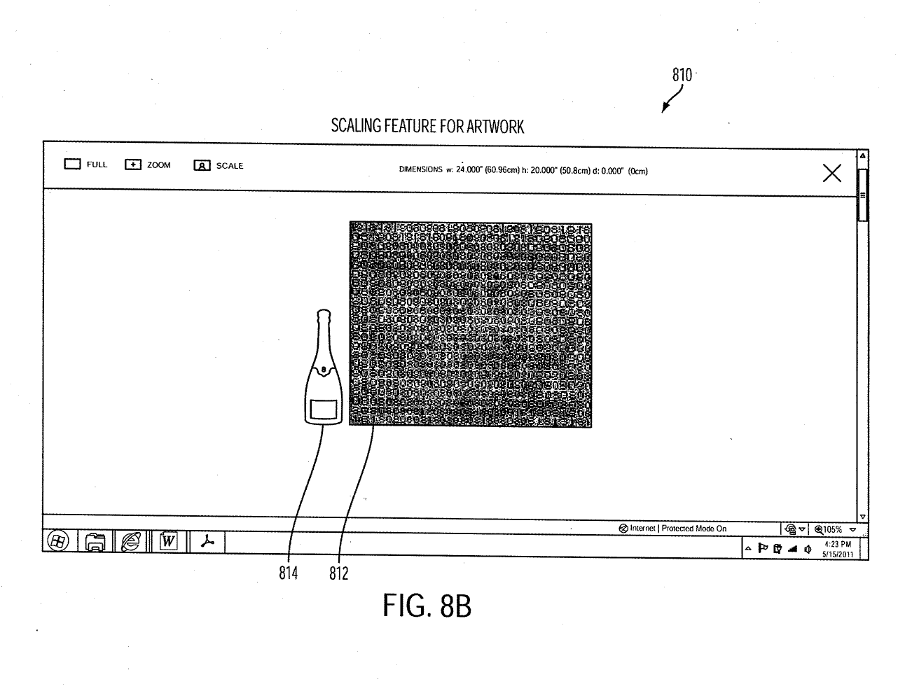

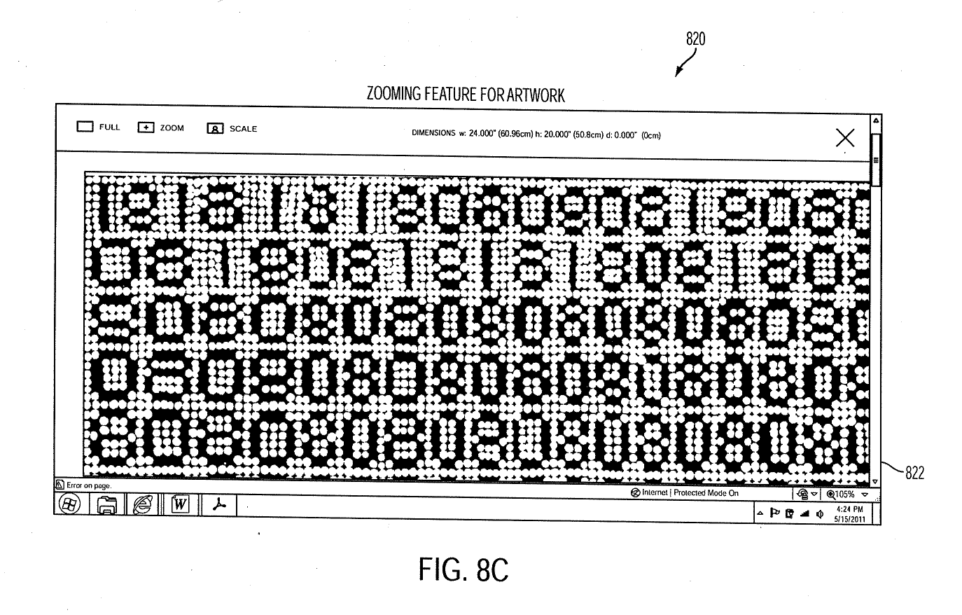

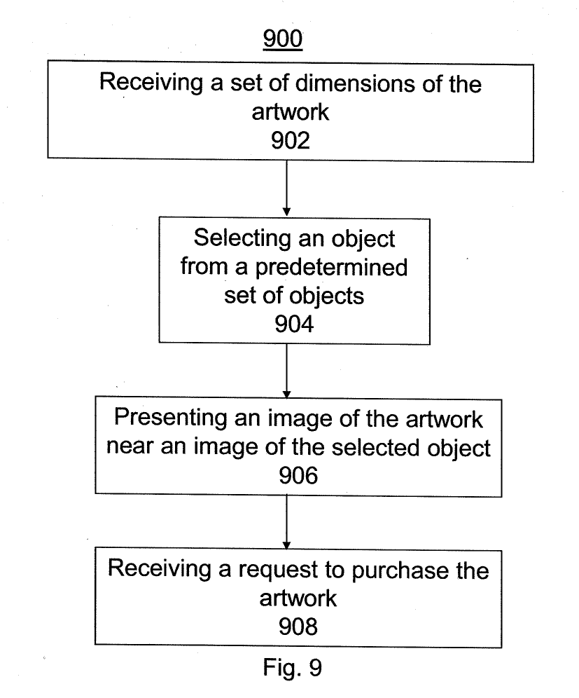

Access to the presentation of the customized set of artworks may be provided by transmitting an invitation to view the presentation to the indicated collectors. A notification, indicating when the presentation is viewed by a collector, may be generated. The presentation may include multiple views of an artwork, such as those of the embodiments of the disclosed subject matter depicted in FIGS. 8A-8C and 9. The presentation may include an option to purchase an artwork of the customized set. A purchase may be transacted according to the embodiments of the disclosed subject matter depicted in FIGS. 4A-4H and 5.

FIGS. 8A-8C depict screenshots of illustrative webpages for a method for presenting an image of artwork to a viewer using a communications network according to one embodiment of the disclosed subject matter.

FIG. 8A depicts a screenshot 800 of an illustrative webpage for viewing an artwork according to one embodiment of the disclosed subject matter. The webpage may include an image 802 of the artwork and metadata 804 associated with the artwork such as a title, artist, price, and dimensions. The webpage may also include a button 806 to initiate a purchase of the artwork.

FIG. 8B depicts a screenshot 810 of an illustrative webpage for viewing an artwork according to one embodiment of the disclosed subject matter. An image of the artwork 812 may be presented near an image of an object 814, selected from a predetermined set of objects based on the dimensions of the artwork. Exemplary objects may include a playing card, a guitar, a race horse, a champagne bottle, and a bicycle. Each object of the predetermined set of objects may correspond to a range of dimensions. An object may be selected based on the artwork dimensions falling within the range of dimensions that corresponds to the selected object.

FIG. 8C depicts a screenshot 820 of an illustrative webpage for viewing an artwork according to one embodiment of the disclosed subject matter. The webpage may include a zoomed in image 822 of the artwork. Other viewing options for the artwork may also be presented, such as a rotational view of the artwork or multiple or multi-angle views of the artwork.

FIG. 9 depicts a method 900 for presenting an image of artwork to a viewer using a processor for executing instructions according to one embodiment of the disclosed subject matter. The method may include receiving a set of dimensions of the artwork 902, selecting an object from a predetermined set of objects 904, presenting an image of the artwork near an image of the selected object 906, and receiving a request to purchase the artwork 908.

The object may be selected based on the received set of dimensions. For example, each object of the predetermined set of objects may correspond to a predetermined range of dimensions. An object may be selected based on the received set of dimensions falling within the predetermined range of dimensions that corresponds to the selected object.

In view of the wide variety of embodiments to which the principles of the present disclosed subject matter can be applied, it should be understood that the illustrated embodiments are exemplary only, and should not be taken as limiting the scope of the present invention. For example, more or fewer elements may be used in the diagrams, elements of different embodiments may be combined; or multiple elements may be included, where only is depicted in an illustrative embodiment, without departing from the scope of the invention. Other aspects, modifications, and embodiments are within the scope of the invention.

1. A method for transacting a purchase of artwork using a communications network, comprising
receiving offers to purchase artwork from collector client devices in communication with the communications network, each offer comprising an offer price;
displaying, on a gallery client device in communication with the communications network, at least one of the offers, collector profile information corresponding to the at least one offer, and an option to accept the at least one offer; and
transmitting to a collector client device an acceptance of one of the offers.

2. The method of claim 1, wherein the accepted offer comprises an offer price that is less than the highest offer price of the transmitted offers.

3. The method of claim 1, wherein the collector profile information includes information about a collector, the information including at least one of a list of artwork owned by the collector and a list of artwork purchased by the collector.

4. The method of claim 1, further comprising transmitting to a collector client device a counteroffer from the gallery client device.

5. The method of claim 1, comprising transmitting via the communications network a message between the gallery client device and a collector client device.

6. A method for transacting a purchase of artwork using a processor for executing instructions, comprising
receiving an artwork selection indicating an artwork to be purchased and a corresponding purchase price;
receiving an insurance selection for insuring the artwork; in response to the received insurance selection, generating an insurance quote for an insurance policy for the artwork;
receiving a shipping selection corresponding to the purchase;
in response to the shipping selection, generating a shipping quote for shipping the artwork based at least in part on characteristics of the artwork;
receiving an installation selection for installing the artwork;
in response to the installation selection, generating an installation quote for installing the artwork based at least in part on characteristics of the artwork;
receiving an invoice request corresponding to the purchase;
in response to the invoice request, generating an invoice comprising at least one of the purchase price, a consumption tax corresponding to the purchase, the insurance quote, the shipping quote, and the installation quote;
receiving a payment selection corresponding to the purchase;
in response to the payment selection, transmitting, via a communications network in communication with the processor, payment information corresponding to the payment selection; and
generating the insurance policy for the artwork.

7. The method of claim 6, further comprising
transmitting, via the communications network, an acceptance of an offer to purchase the artwork, the offer comprising a price, wherein the artwork selection comprises the offer to purchase.

8. The method of claim 6, wherein the step of generating a shipping quote comprises calculating a cost based on at least one of an origin location from where the artwork will be shipped, a destination location to where the artwork will be shipped, at least one dimension related to the artwork, and a packing cost to pack the artwork.

9. The method of claim 8, wherein the step of calculating a cost further comprises
calculating a volume corresponding to the artwork based on the at least one dimension;
determining an origin cost based on the volume and the origin location;
determining a transit cost based on the volume, the origin location, and the destination location;
determining a packing cost based on the volume; and
calculating a sum of the origin cost, packing cost, and transit cost.

10. A method for managing an inventory of artwork using a processor for executing instructions, comprising
receiving a request for a customized set of artworks from an artwork database in communication with the processor, the artwork database storing data corresponding to a plurality of artworks, comprising
receiving at least one indicator corresponding to an artwork from the artwork database to include in the customized set, and
receiving at least one indicator corresponding to a collector from a collector database in communication with the processor, the collector database storing data corresponding to a plurality of collectors; and
in response to receiving the request for the customized set, providing, to the indicated collectors, access via a communications network to a presentation of the customized set of artworks.

11. The method of claim 10, comprising
transmitting to a collector client device in communication with the communications network an invitation to view the presentation of the customized set of artworks; and
generating a notification comprising an indicator corresponding to a collector, when the presentation of the customized set of artworks is viewed by the collector.

12. The method of claim 10, comprising
transmitting to a collector client device in communication with the communications network the presentation of the customized set of artworks, the presentation including an option to purchase an artwork of the customized set;
accepting a selection of the option to purchase; and
in response to the selection of the option to purchase, transacting a purchase of the artwork.

13. The method of claim 10, further comprising
receiving an artwork selection indicating an artwork of the artwork database to be purchased and a corresponding purchase price;
receiving an insurance selection for insuring the artwork;
in response to the received insurance selection, generating an insurance quote for an insurance policy for the artwork;
receiving a shipping selection corresponding to the purchase;
in response to the shipping selection, generating a shipping quote for shipping the artwork based at least in part on characteristics of the artwork;
receiving an installation selection for installing the artwork;
in response to the installation selection, generating an installation quote for installing the artwork based at least in part on characteristics of the artwork;
receiving an invoice request corresponding to the purchase;
in response to the invoice request, generating an invoice comprising at least one of the purchase price, a consumption tax corresponding to the purchase, the insurance quote, the shipping quote, and the installation quote;
receiving a payment selection corresponding to the purchase;
in response to the payment selection, transmitting, via a communications network in communication with the processor, payment information corresponding to the payment selection; and
generating the insurance policy for the artwork.

14. The method of claim 10, further comprising accepting a request to modify data stored in the artwork database, the stored data comprising images and metadata associated with each artwork of the plurality of artworks.

15. The method of claim 14, wherein the artwork metadata comprises a title, an artist, and at least one of dimensions, a price, an art category, year, and an exhibition including the artwork.

16. The method of claim 10, further comprising accepting a request to modify data stored in the collector database, the stored data comprising a name, contact information, and a description of artistic preferences.

17. The method of claim 10, wherein the presentation of the customized set of artworks comprises at least one of an image of the artwork near an image of the selected object, a zoomed image of the artwork, a rotational image of the artwork, and multiple views of the artwork.

18. A method for presenting an image of artwork to a viewer using a processor for executing instructions, comprising
receiving a set of dimensions of the artwork,
selecting an object from a predetermined set of objects based on the received set of dimensions, and
presenting to the viewer an image of the artwork near an image of the selected object.

19. The method of claim 18, wherein each object of the predetermined set of objects corresponds to a predetermined range of dimensions.

20. The method of claim 19, wherein an object is selected based on the received set of dimensions falling within the predetermined range of dimensions that corresponds to the selected object.

21. The method of claim 18, comprising receiving a request from the viewer to purchase the artwork.
